(19) United States
(12) Patent Application Publication
(10) Pub. No.: US 2022/0203302 A1
(43) Pub. Date: Jun. 30, 2022

(54) CASSETTE TYPE ELECTRODIALYSIS UNIT AND MODULE COMPRISING THE SAME

(71) Applicant: INDUSTRIAL TECHNOLOGY RESEARCH INSTITUTE, Hsinchu (TW)

(72) Inventors: Yi-Tze TSAI, Zhongpu Township (TW); Guan-You LIN, Zhubei City (TW); Hsin-Ju YANG, Taichung City (TW)

(73) Assignee: INDUSTRIAL TECHNOLOGY RESEARCH INSTITUTE, Hsinchu (TW)

(21) Appl. No.: 17/137,902

(22) Filed: Dec. 30, 2020

(51) Int. Cl. B01D 61/50; B01D 63/08; C02F 1/469

(52) U.S. Cl. CPC B01D 61/50; B01D 63/082; C02F 1/4693; B01D 2313/14; B01D 2313/13; B01D 2313/20; B01D 2319/02; B01D 2313/04

(57) ABSTRACT

A cassette type electrodialysis unit includes an accommodating box, a filter membrane group and a cover member disposed on the accommodating box. The accommodating box includes a membrane support, a membrane limiting wall and an accommodating opening. The membrane limiting wall is disposed on and surrounds the membrane support to form the accommodation opening. The filter membrane group is disposed on the membrane support and abuts an inner side of the membrane limiting wall, and includes a first ion exchange membrane, a second ion exchange membrane and a spacer disposed therebetween. The cover member includes a main body, an opening penetrating the main body, and a pressing portion. A first side of the main body adjacent to the filter membrane group has a peripheral area and an inner area closer to the opening than the outer area, and the pressing portion is formed on the inner area.

### TECHNICAL FIELD

The disclosure relates in general to an electrodialysis unit and a module comprising the same, and more particularly to a cassette type electrodialysis unit and a module comprising the same.

### BACKGROUND

Electrodialysis (Electrodialysis, ED) technology is a membrane separation technology driven by an electric field for different purposes such as desalination, concentration and purification, so it is also called electrochemical desalination (ED). The electrodialysis system allows water to flow through alternately arranged anion and cation exchange membranes. Under the action of the direct current electric field of the electrode plates, the anions and cations are driven to move to selectively permeate the anion and cation exchange membranes so that the anions and cations can be removed or concentrated in another water channel to achieve the purpose of water purification.

A common electrodialysis technique uses screw rods to penetrate all anion and cation exchange membranes and electrode plates to press the anion and cation exchange membranes, to prevent water from leaking out, but this pressing method will only produce the compression stress with a dot shape at the positions where the screw rods penetrate. Further, each of the screw rods is required to be screwed, and it is easy to have the problems that each of the screw rods has different tightness in screwing. It is not only difficult to control and unify the strength for screwing the screw rods, but also limited in the amount for stacking the anion and cation exchange membranes due to this stress difference, and it is more likely to cause insufficient water tightness in the central portion between anion and cation exchange membranes, resulting in the mixing of purified water and sewage, and the effect of electrodialysis cannot be achieved.

The common electrodialysis technique also has a pressing plate added on the outermost side, and the screw rods only penetrate the pressing plate, so as to solve the problem of uneven compression stress. However, since the anion and cation exchange membranes are not fixed by the screw rods, it causes many derived problems from the stacking action of anion and cation exchange membranes. For example, when the size of the anion and cation exchange membranes is as large as 80 cm×160 cm, deviations are likely to occur during the stacking process, which will increase the risk of mixing internal clean water and sewage. Or, when the number of anion and cation exchange membranes is large, not only the stacking action is time-consuming, but also the crane is needed for hoist, and the assembly efficiency is very poor. In addition, if water leakage or assembly errors are discovered after the assembly is completed, they can only be disassembled for inspection, and then the assembly action should be repeated.

Therefore, there is still an urgent need to study an improved electrodialysis device to solve the above technical problems.

### SUMMARY

According to an embodiment of the present disclosure, a cassette type electrodialysis unit is provided. The cassette type electrodialysis unit includes an accommodating box, a filter membrane group and a cover member. The accommodating box includes a membrane support, a membrane limiting wall and an accommodating opening. The membrane limiting wall is disposed on and surrounds the membrane support. The accommodating opening is formed between the membrane support and the membrane limiting wall. The filter membrane group is disposed on the membrane support and abuts an inner side of the membrane limit wall. The filter membrane group includes a plurality of first ion exchange membranes and a plurality of second ion exchange membranes alternately disposed; and a plurality of spacers. The spacers are disposed between the first ion exchange membranes and the second ion exchange membranes. The cover member is disposed on the accommodating box, and the cover member includes at least one opening, a body portion, and a pressing portion. The at least one opening penetrates the body portion, and a first side of the body portion adjacent to the filter membrane group side has a peripheral area and an inner area, the inner area is closer to the opening than the peripheral area, and the pressing portion is formed on the inner area.

According to another embodiment of the present disclosure, a cassette type electrodialysis module is provided. The cassette type electrodialysis module includes a plurality of cassette type electrodialysis units and a positioning assembly. Each of the cassette type electrodialysis units includes an accommodating box, a filter membrane group, and a cover member. The accommodating box includes a membrane support, a membrane limiting wall and an accommodating opening. The membrane limiting wall is disposed on and surrounds the membrane support. The accommodating opening is formed between the membrane support and the membrane limiting wall. The filter membrane group is disposed on the membrane support and abuts an inner side of the membrane limiting wall. The filter membrane group includes a plurality of first ion exchange membranes and a plurality of second ion exchange membranes alternately disposed; and a plurality of spacers. The spacers are disposed between the first ion exchange membranes and the second ion exchange membranes. The cover member is disposed on the accommodating box, and the cover member includes at least one opening, a body portion, and a pressing portion, wherein the at least one opening penetrates the body portion, and a first side of the body portion adjacent to the filter membrane group has a peripheral area and an inner area, the inner area is closer to the opening than the peripheral area, and the pressing portion is formed on the inner area. The positioning assembly is disposed on the outer side of the membrane limiting wall, so that the cassette type electrodialysis units are aligned with each other.

According to a further embodiment of the present disclosure, a cassette type electrodialysis module is provided. The cassette type electrodialysis module includes a plurality of cassette type electrodialysis units and a positioning assembly. Each of the cassette type electrodialysis units includes an accommodating box, a filter membrane group, and a cover member. The accommodating box includes a membrane support, a membrane limiting wall and an accommodating opening. The membrane limiting wall is disposed on and surrounds the membrane support. The accommodating opening is formed between the membrane support and the membrane limiting wall. The filter membrane group is disposed on the membrane support and abuts an inner side of the membrane limiting wall. The filter membrane group includes a plurality of first ion exchange membranes and a plurality of second ion exchange membranes alternately disposed; and a plurality of spacers. The spacers are disposed between the first ion exchange membranes and the second ion exchange membranes. The cover member is disposed on the accommodating box, and the cover member includes at least one opening, a body portion, and a pressing portion, wherein the at least one opening penetrates the body portion, and a first side of the body portion adjacent to the filter membrane group has a peripheral area and an inner area, the inner area is closer to the opening than the peripheral area, and the pressing portion is formed on the inner area. The positioning assembly is disposed on a first side and a second side of each of the cassette type electrodialysis units, and the first side of each of the cassette type electrodialysis units is opposite to the second side of each of the cassette type electrodialysis units.

In order to have a better understanding of the above-mentioned and other aspects of the present disclosure, the following embodiments are particularly provided, and the accompanying drawings are described in detail as follows:

### BRIEF DESCRIPTION OF THE DRAWINGS

FIG. 1 illustrates a perspective view of a cassette type electrodialysis unit according to an embodiment of the present disclosure;

FIG. 2 illustrates an exploded schematic view of a cassette type electrodialysis unit according to an embodiment of the present disclosure;

FIG. 3 illustrates a cross-sectional view of a cassette type electrodialysis unit according to an embodiment of the present disclosure;

FIGS. 4 to 6 illustrate schematic views of the assembly process of the cassette type electrodialysis unit according to an embodiment of the present disclosure;

FIG. 7 illustrates an exploded schematic view of a cassette type electrodialysis module according to an embodiment of the present disclosure;

FIG. 8 illustrates a perspective view of a cassette type electrodialysis module according to an embodiment of the present disclosure;

FIG. 9 illustrates a side view of a cassette type electrodialysis module according to a further embodiment of the present disclosure;

FIG. 10A illustrates a perspective view of a second side of a cassette type electrodialysis unit according to a further embodiment of the present disclosure;

FIG. 10B illustrates a perspective view of a first side of a cassette type electrodialysis unit according to a further embodiment of the present disclosure;

FIG. 11A illustrates a perspective view of the second side of a cassette type electrodialysis unit according to a further embodiment of the present disclosure;

FIG. 11B illustrates a perspective view of the first side of a cassette type electrodialysis unit according to a further embodiment of the present disclosure;

FIG. 12 shows a perspective view of a cassette type electrodialysis module according to a further embodiment of the present disclosure; and

FIG. 13 illustrates a perspective view of a cassette type electrodialysis module according to a further embodiment of the present disclosure

### DETAILED DESCRIPTION

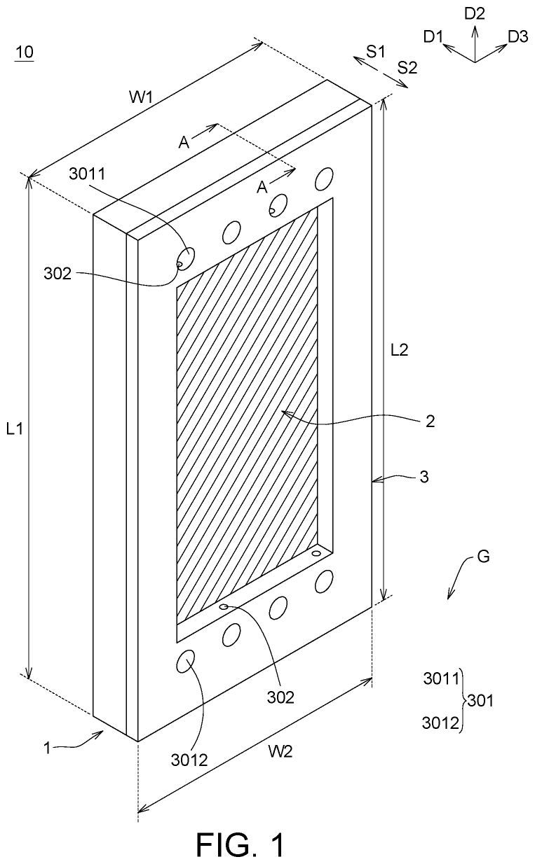

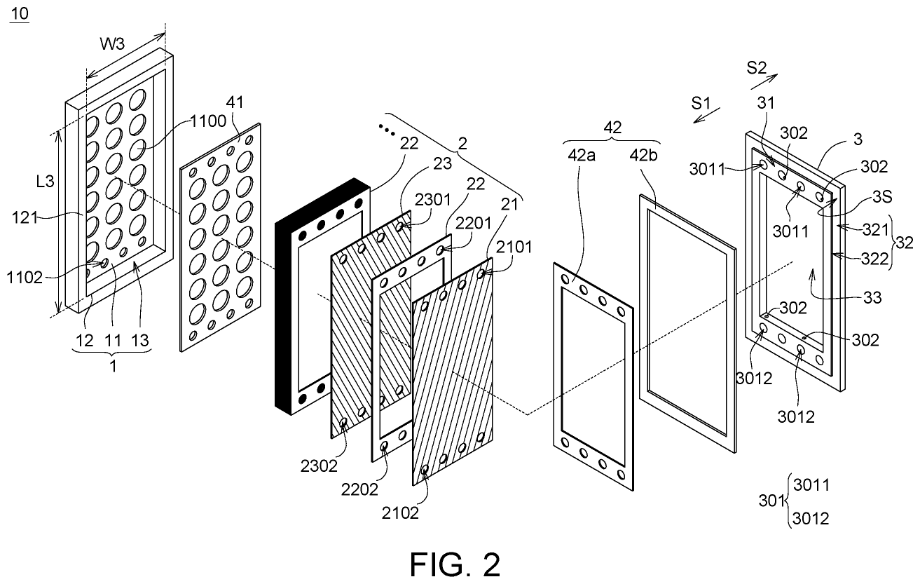

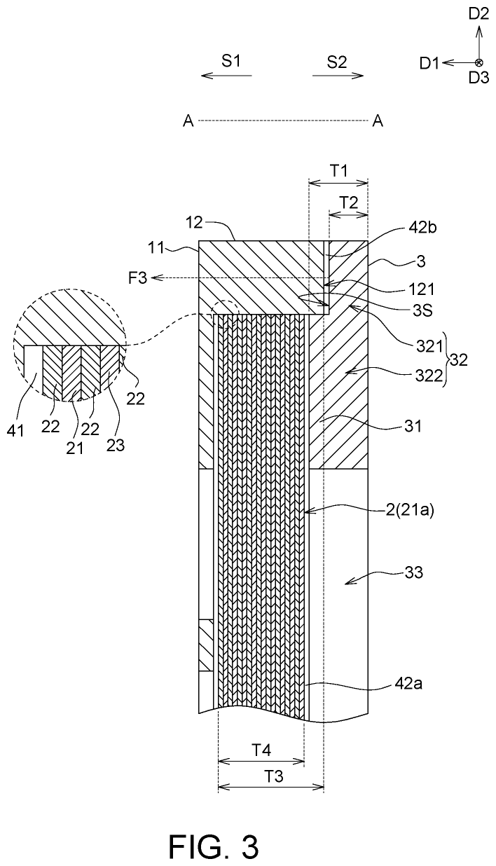

FIG. 1 illustrates a perspective view of a cassette type electrodialysis unit 10 according to an embodiment of the present disclosure. FIG. 2 illustrates an exploded schematic view of the cassette type electrodialysis unit 10 according to an embodiment of the present disclosure. FIG. 3 illustrates a cross-sectional view of a cassette type electrodialysis unit 10 according to an embodiment of the present disclosure.

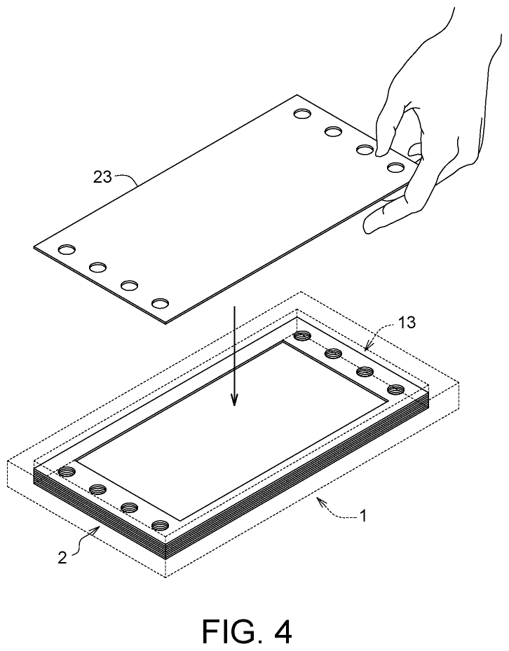

Referring to FIGS. 1 and 2 at the same time, the cassette type electrodialysis unit 10 includes an accommodating box 1, a filter membrane group 2 and a cover member 3. The filter membrane group 2 is disposed between the accommodating box 1 and the cover member 3. As shown in FIG. 1, an outer side of the accommodating box 1 has a thickness in the first direction D1, has a length L1 in the second direction D2, and has a width W1 in the third direction D3. The first direction D1, the second direction D2, and the third direction D3 are, for example, perpendicular to each other. The outer side of the cover member 3 has a length L2 in the second direction D2 and has a width W2 in the third direction D3. The length L1 may be equal to the length L2, and the width W1 may be equal to the width W2, but the present disclosure is not limited thereto. Unless otherwise specified below, the thickness of each element refers to the thickness formed in the first direction, the length is the length formed in the second direction, and the width is the width formed in the third direction. In FIG. 1, the cassette type electrodialysis unit 10 of the present disclosure is vertically disposed, for example, the length direction (i.e., the second direction D2) of the accommodating box 1 is perpendicular to the plane G where the cassette type electrodialysis unit 10 is placed (such as the plane formed by the first direction D1 and the third direction D3 in FIG. 1), but the present disclosure is not limited thereto. The cassette type electrodialysis unit 10 may also be horizontally disposed, for example, the length direction (i.e., the second direction D2) of the accommodating box 1 is parallel to the plane G for placement, as shown in FIGS. 4-6.

Referring to FIG. 2, the accommodating box 1 includes a membrane support 11, a membrane limiting wall 12, and an accommodating opening 13. The membrane limiting wall 12 is disposed on and surrounds the membrane support 11. The accommodating opening 13 is formed between the membrane support 11 and the membrane limiting wall 12. The accommodating box 1 is, for example, a rectangular box-shaped structure, but the disclosure is not limited thereto.

The filter membrane group 2 is disposed on the membrane support 11 and abuts the inner side of the membrane limiting wall 12. That is, the filter membrane group 2 is disposed in the accommodating opening 13. The filter membrane group 2 includes a plurality of first ion exchange membranes 21 and a plurality of second ion exchange membranes 23 alternately disposed, and includes a plurality of spacers 22 disposed between the first ion exchange membranes 21 and the second ion exchange membranes 23. The first ion exchange membranes 21, the second ion exchange membranes 23 and the spacers 22 can be regarded as multiple membranes in the filter membrane group 2. In one embodiment, the first ion exchange membranes 21 are anion exchange membranes, and the second ion exchange membranes 23 are cation exchange membranes. In another embodiment, the first ion exchange membranes 21 are cation exchange membranes, and the second ion exchange membranes 23 are anion exchange membranes. The sizes (for example, the length and width) of each of the first ion exchange membranes 21, each of the second ion exchange membranes 23, and each of the spacers 22 in the filter membrane group 2 may be the same as each other, and may correspond to the sizes (for example, the length and width) of the accommodating opening 13 (or an exposed area of the membrane support 11 defined by the membrane limiting wall 12), but it is not limited thereto. The user may select filter membrane group 2 of different sizes or different numbers of membranes according to requirements (for example, membrane compression conditions and water purification standards of the filter membrane group 2). In some embodiments, the length L3 of the accommodating opening 13 may be between 40 cm and 160 cm, and the width W3 of the accommodating opening 13 may be between 20 cm and 80 cm, but the present disclosure is not limited thereto.

Since the size of the accommodating opening 13 enclosed by the membrane limiting wall 12 corresponds to the size of the first ion exchange membranes 21, the second ion exchange membranes 23 and the spacers 22, when the first ion exchange membranes 21, the second ion exchange membranes 23 and the spacers 22 are put into the accommodating opening 13 one by one, the inner side of the membrane limiting wall 12 can enable the first ion exchange membranes 21, the second ion exchange membranes 23 and the spacers 22 aligned with each other and fixed on the membrane support 11, and there is no need to use glue to fix the first ion exchange membranes 21, the second ion exchange membranes 23 and the spacers 22, and no extra manpower is required to align the first ion exchange membranes 21, the second ion exchange membranes 23 and the spacers 22 with each other, even a large-sized filter membrane group 2 can still be assembled easily. Compared with a comparative example of the electrodialysis unit without the membrane limiting wall, since the present disclosure has the membrane limiting wall 12, it can save time and effort when assembling the cassette type electrodialysis unit 10, and can accurately align the first ion exchange membranes 21, the second ion exchange membranes 23 and the spacers 22, which may effectively reduce the internal water leakage caused by the deviation of the position of the membranes, thereby eliminating the risk of mixing of purified water and sewage. In some embodiments, the thickness of the membrane limiting wall 12 in the first direction D1 may be equal to or greater than the thickness of the filter membrane group 2 in the first direction D1.

In addition, after the filter membrane group 2 is disposed on the membrane support 11, the cover member 3 may be disposed on the accommodating box 1 and the filter membrane group 2. That is, the cover member 3 is detachably combined with the accommodating box 1, and the filter membrane group 2 is disposed between the accommodating box 1 and the cover member 3. The cover member 3 includes at least one opening 33, a body portion 32, and a pressing portion 31, wherein the opening 33 penetrates the body portion 32, and the body portion 32 has a first side S1 adjacent to the filter membrane group 2 and a second side S2 away from the filter membrane group 2, the first side S1 and the second side S2 are disposed on opposite sides of the body portion 32. The first side S1 of the body portion 32 has a peripheral area 321 and an inner area 322. The inner area 322 is closer to the opening 33 than the peripheral area 321, and the pressing portion 31 is formed on the inner area 322, such as surrounding the opening 33. That is, the pressing portion 31 is a protruding portion on the first side S1 of the body portion 32. In the present embodiment, the central portion of the cover member 3 has an opening 33, but the present disclosure is not limited thereto. In other embodiments, the central portion of the cover member 3 may have multiple openings. The size (for example, length and width) of the pressing portion 31 may correspond to (for example, equal to, slightly larger than, or slightly smaller than) the size (for example, length and width) of the filter membrane group 2. After the cover member 3 is detachably combined with the accommodating box 1, the pressing portion 31 can provide a face-like compression stress to evenly squeeze the filter membrane group 2 so that the thickness of the filter membrane group 2 is reduced (as shown in FIG. 3), compared with the comparative example of squeezing the filter membrane group by dot-like compression stress, the pressing portion 31 in the present disclosure solves the problem of uneven force of the filter membrane group 2, and provides a better leakage-proof effect.

Referring to FIG. 2, in some embodiments, the cassette type electrodialysis unit 10 further includes a first sealing member 41 and a second sealing member 42. The first sealing member 41 is disposed between the membrane support 11 and the filter membrane group 2. For example, the first sealing member 41 is conformal to the profile of the inner surface of the membrane support 11, and is attached to the inner surface of the membrane support 11, and has a size corresponding to the accommodating opening 13. The second sealing member 42 is disposed between the pressing portion 31 and the filter membrane group 2, and between the peripheral area 321 and the membrane limiting wall 12. Furthermore, the second sealing member 42 includes a first portion 42a and a second portion 42b. The cover member 3 has an inner surface 3S corresponding to the first side S1. The first portion 42a of the second sealing member 42 is disposed on the inner surface 3S corresponding to the pressing portion 31, and is conformal to the profile of the inner surface 3S corresponding to the pressing portion 31, and is attached to the inner surface 3S corresponding to the pressing portion 31. The second portion 42b of the second sealing member 42 is disposed on the inner surface 3S corresponding to the peripheral area 321, and is conformal to the profile of the inner surface 3S corresponding to the peripheral area 321, and is attached to the inner surface 3S corresponding to the peripheral area 321. The peripheral area 321 of the cover member 3 and the second portion 42b of the second sealing member 42 disposed thereon are used to be detachably connected to an upper edge 121 of the membrane limiting wall 12. The pressing portion 31 of the cover member 3 and the first portion 42a of the second sealing member 42 disposed thereon are used for detachably connecting the filter membrane group 2 (as shown in FIG. 3). The pressing portion 31 of the cover member 3 may be used to compress the filter membrane group 2 (as shown in FIG. 3). In some embodiments, the first sealing member 41 and the second sealing member 42 may be any soft padding material, and the material of the soft padding material is, for example, silica gel, rubber, polyethylene (PE) or other suitable materials. The first sealing member 41 may provide water tightness between the first piece of the ion exchange membranes closest to the membrane support 11 (for example, the first ion exchange membrane 21 or the second ion exchange membrane 23) and the membrane support 11. The second sealing member 42 may provide the water tightness between the first piece of the ion exchange membranes closest to the cover member 3 (in the present embodiment, it is the first ion exchange membrane 21, but in other embodiments, it may be the second ion exchange membrane 23) and the cover member 3.

Referring to FIGS. 1 and 2, the cover member 3 also has a plurality of holes 301 extending along a first direction D1 and a plurality of extending apertures 302 extending along a second direction D2. The first direction D1 is parallel to the normal direction of the inner surface 3S, and the second direction D2 is perpendicular to the normal direction of the inner surface 3S. The holes 301 of the cover member 3 penetrate the pressing portion 31 and the body portion 32, and the extending apertures 302 connect the corresponding holes 301 to the opening 33. Wherein, the holes 301 of the cover member 3 include a first group of holes 3011 and a second group of holes 3012. The first group of holes 3011 and the second group of holes 3012 are formed on two opposite sides of the opening 33 (for example, the upper side and the lower side). The holes 301 in the first group of holes 3011 are separated from each other along a third direction D3, and the holes 301 in the second group of holes 3012 are separated from each other along the third direction D3. In the second direction D2, the extending apertures 302 connected to the holes 301 in the first group of holes 3011 are separated from the extending apertures 302 connected to the holes 301 in the second group of holes 3012. In other words, the extending apertures 302 on the upper side and the extending apertures 302 on the lower side are respectively connected to the first group of holes 3011 and the second group of holes 3012 that do not overlap each other in the second direction D2.

Furthermore, each of the first ion exchange membranes 21 includes a first group of holes 2101 and a second group of holes 2102 disposed on two opposite sides (for example, the upper side and lower side), and each of the second ion exchange membranes 23 includes a first group of holes 2301 and a second group of holes 2302 disposed on two opposite sides (for example, the upper side and lower side), and each of the spacers 22 includes a first group of holes 2201 and a second group of holes 2202 disposed on two opposite sides (for example, the upper side and lower side). A membrane support 11 includes a plurality of large holes 1100 and a plurality of small holes 1102, wherein the small holes 1102 are disposed on two opposite sides of the large holes 1100 (for example, the upper side and the lower side), and the small holes 1102 include a first group of holes (not shown) disposed on the upper side of the large holes 1100 and a second group of holes 1102 disposed on the lower side of the large holes 1100.

With the assistance of the membrane limiting wall 12, the first group of holes (not shown) of the membrane support 11, the first group of holes 3011 of the cover member 3, the first group of holes 2101 of each of the first ion exchange membranes 21, the first group of holes 2301 of each of the second ion exchange membranes 23, and the first group of holes 2201 of each of the spacers 22 may correspond to each other; the second group of holes 1102 of the membrane support 11, the second group of holes 3012 of the cover member 3, the second group of holes 2102 of each of the first ion exchange membranes 21, the second group of holes 2302 of each of the second ion exchange membranes 23, and the second group of holes 2202 of each of the spacers 22 may correspond to each other.

Referring to FIG. 3, the cover member 3 has an inner surface 3S corresponding to the first side S1; in the normal direction F3 of the inner surface 3S, a thickness T1 formed by the pressing portion 31 and the body portion 32 disposed in the inner area 322 together is greater than a thickness T2 formed by the body portion 32 in the peripheral area 321. Before the filter membrane group 2 is compressed by the pressing portion 31, the filter membrane group 2 has a first thickness T3. In the present embodiment, before the filter membrane group 2 is compressed by the pressing portion 31, the upper surface 21a of the first ion exchange membrane 21 in the filter membrane group 2 farthest away from the membrane support 11 may be coplanar with the upper edge 121 of the membrane limiting wall 12, but the present disclosure is not limited thereto. After the filter membrane group 2 is compressed by the pressing portion 31, the filter membrane group 2 has a second thickness T4, wherein the second thickness T4 is smaller than the first thickness T3. The second thickness T4 has a compression percentage R to the first thickness T3, the compression percentage R=(the first thickness T3−the second thickness T4)/the first thickness T3, and the compression percentage R may range from 3% to 15%, for example, 7% to 10%. It can be seen that as long as the thickness formed by the pressing portion 31 and the body portion 32 disposed in the inner area 322 together, the thickness of the membrane limiting wall 12, and the thickness of the filter membrane group 2 are designed, after the accommodating box 1 is completely covered by the cover member 3, the required compression percentage R of the filter membrane group 2 may be obtained, which meets the degree of tightness required by the filter membrane group 2.

In some embodiments, the number of membrane pairs formed by the first ion exchange membranes 21 and the second ion exchange membranes 23 in the filter membrane group 2 may range from 20 to 50 pairs. The compression percentage R of the filter membrane group 2 may range from 3% to 15%. The water production of a single cassette electrodialysis unit 10 may range from 10 to 100 LPM, and the desalination efficiency may range from 10% to 40%, but the present disclosure is not limited thereto. It can be seen that the use of the cassette type electrodialysis unit 10 according to an embodiment of the present disclosure for electrodialysis not only has the advantages of convenient assembly, accurate positioning, and good water tightness, but also maintains a good water production and desalination performance.

FIGS. 4-6 illustrate schematic views of the assembly process of the cassette type electrodialysis unit 10 according to an embodiment of the present disclosure.

Referring to FIG. 4, firstly, an accommodating box 1 is provided, and then the second ion exchange membrane 23, the spacer 22, the first ion exchange membrane 21 and the spacer 22 in the filter membrane group 2 are sequentially placed in the accommodating opening 13. In the present embodiment, the uppermost membrane in the filter membrane group 2 (that is, the membrane farthest away from the membrane support 11) is the first ion exchange membrane 21, and the lowest membrane is the second ion exchange membrane. 23. However, the present disclosure is not limited thereto.

Referring to FIG. 5, when any membrane of the first ion exchange membrane 21, the spacers 22 or the second ion exchange membrane 23 is placed in the accommodating opening 13, since the sizes of the membrane support 11 and the filter membrane group 2 are the same, the membrane limiting wall 12 may be used to automatically modify and arrange the angle and position of membranes falling to the membrane support 11 while membranes are slid into the accommodating box 1, so that the filter membrane group 2 is orderly placed on the membrane support 11, and there is no need to adjust the positions of each of membranes one by one to align them. Even if the size of the filter membrane group 2 is large, it can be operated simply and quickly in the same way. Therefore, the assembly efficiency can be greatly improved, and the positional relationship of each of membranes may be ensured. Thus, the internal water leakage problem caused by the deviation of the membrane position can be effectively reduced, and the risk of mixing of purified water and sewage can be eliminated.

Referring to FIG. 6, after the filter membrane group 2 is placed in the accommodating opening 13, the pressing portion 31 of the cover member 3 faces the filter membrane group 2, and the cover member 3 is detachably combined with the filter membrane group 2 and the accommodating box 1, the upper edge 121 of the accommodating box 1 is tightly combined with the peripheral area 321 of the body portion 32 of the cover member 3 and the first portion 42a of the second sealing member 42 (not shown) disposed thereon, so that the filter membrane group 2 is compressed by the pressing portion 31, as shown in FIG. 3.

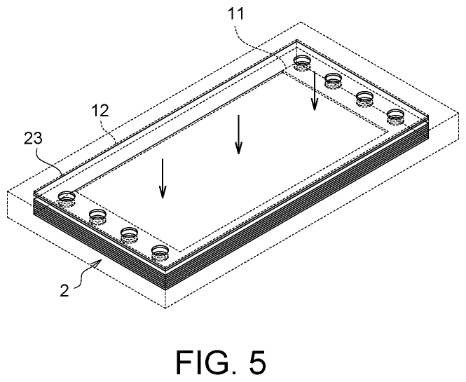

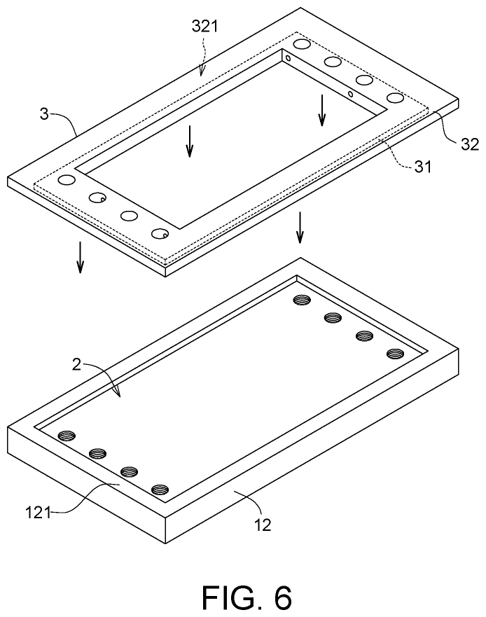

FIG. 7 illustrates an exploded schematic view of the cassette type electrodialysis module 10M according to an embodiment of the present disclosure. FIG. 8 illustrates a perspective view of a cassette type electrodialysis module 10M according to an embodiment of the disclosure.

Referring to FIGS. 7 and 8 at the same time, the cassette type electrodialysis module 10M includes a first electrode cassette 51b, a second electrode cassette 52b, a plurality of cassette type electrodialysis units 10A and 10B, a third sealing member 43, two fourth sealing members 44a and 44b, a clamping assembly 5b, and a positioning assembly 7b. The cassette type electrodialysis units 10A and 10B are disposed between the first electrode cassette 51b and the second electrode cassette 52b. The first electrode cassette 51b and the second electrode cassette 52b may be used to operate an electric field, and can be used as a positive electrode or a negative electrode, respectively.

Each of the cassette type electrodialysis units 10A and 10B in FIGS. 7 and 8 is the same as the cassette type electrodialysis unit 10 shown in FIGS. 1 and 2, and the similarities will not be described again. In the present embodiment, only two cassette type electrodialysis units 10A and 10B are exemplarily shown, but the present disclosure is not limited thereto, and the cassette type electrodialysis module 10M of the present disclosure may include any number of cassettes type of electrodialysis unit, depending on the required number of pairs of anion exchange membranes and cation exchange membranes. Generally speaking, in the comparative example where only the screw rod is used to fix all the anion and cation exchange membranes and the electrode plates or the comparative example where only the screw rod is used to penetrate the pressing plate to tighten the anion and cation exchange membranes and the electrode plates, the number of membrane pairs of the anion exchange membranes and the cation exchange membranes may only be up to 400 pairs, otherwise the compression stress at the center of the stack of the anion and cation membranes will be too small, causing the membranes in the middle to slip off. In contrast, the cassette type electrodialysis module 10M of the present disclosure may include any number of cassette type electrodialysis units 10A, 10B . . . , anion exchange membranes and cation exchange membranes in each of the cassette type electrodialysis units 10A, 10B . . . may be subjected to sufficient compression stress to allow the stacks of anion and cation membranes to achieve the desired compression ratio, so the cassette type electrodialysis module 10M can have any number of pairs of anion exchange membranes and cation exchange membranes (that is, may be greater than 400 pairs). Furthermore, during the electrodialysis process, if an abnormality is found in the cassette type electrodialysis units 10A, 10B . . . , as long as the cassette type electrodialysis unit with a problem is dealt with (for example, any one of cassette type electrodialysis units can be easily removed or replaced), it is not needed to interrupt the electrodialysis process for too long. Compared with the traditional electrodialysis module, the cassette type electrodialysis module 10M saves time and effort in maintenance.

In addition, a third sealing member 43 may be disposed between adjacent cassette type electrodialysis units 10A and 10B to increase water tightness. In the present embodiment, the third sealing member 43 is conformal to the surface profile of the first side (that is, the side far away from the filter membrane group 2) of the membrane support 11 of the cassette type electrodialysis unit 10B, and is attached to the first side of the membrane support 11 of the cassette type electrodialysis unit 10B (that is, the side far away from the filter membrane group 2), but the present disclosure is not limited thereto. In other embodiments, the third sealing member 43 may be conformal to the surface profile of the second side (that is, the side far away from the filter membrane group 2) of the cover member 3 of the cassette electrodialysis unit 10A, and is attached to the second side (the side far away from the filter membrane group 2) of the cover member 3 of the cassette type electrodialysis unit 10A. In addition, the number of the third sealing member 43 may be determined according to the number of the cassette type electrodialysis unit. When the number of the cassette type electrodialysis unit is N, the number of the third sealing 43 may be N−1, as long as a third sealing member 43 is disposed between two adjacent cassette type electrodialysis units.

In some embodiments, the two fourth sealing members 44 include fourth sealing members 44a and 44b, and the fourth sealing members 44a and 44b are respectively disposed between the first electrode cassette 51b and the cassette type electrodialysis unit 10A closest to the first electrode cassette 51b in the cassette type electrodialysis units 10A and 10B, and between the second electrode cassette 52b and the cassette type electrodialysis unit 10B closest to the second electrode cassette 52b in the cassette type electrodialysis units 10A and 10B. In the present embodiment, the fourth sealing member 44a is conformal to the surface profile of the first side (that is, the side far away from the filter membrane group 2) of the membrane support 11 of the cassette type electrodialysis unit 10A, and is attached to the first side (that is, the side far away from the filter membrane group 2) of the membrane support 11 of the cassette type electrodialysis unit 10A, the fourth sealing member 44b is conformal to the surface profile of the first side of the second electrode cassette 52b (that is, the side adjacent to the cassette type electrodialysis unit 10B), and is attached to the first side of the second electrode cassette 52b (that is, the side adjacent to the cassette type electrodialysis unit 10B), but the present disclosure is not limited thereto. In other embodiments, the fourth sealing member 44a is conformal to the surface profile of the second side of the first electrode cassette 51b (that is, the side adjacent to the cassette type electrodialysis unit 10A), and is attached to the second side of the first electrode cassette 51b the fourth sealing member 44b is conformal to the surface profile of the second side S2 of the cover member 3 (that is, the side farther away from the filter membrane group 2), and is attached to the second side S2 of the cover member 3 (that is, the side farther away from the filter membrane group 2). In the present embodiment, the appearance of the two fourth sealing members 44a and 44b may be different from each other. In other embodiments, the appearance of the two fourth sealing members 44a and 44b may be the same as each other.

In some embodiments, the positioning assembly 7b is disposed on the outer side of the membrane limiting wall 12 of the cassette type electrodialysis units 10A and 10B, the outer side of the first electrode cassette 51b and the second electrode cassette 52b, so that the cassette type electrodialysis units 10A and 10B, the first electrode cassette 51b and the second electrode cassette 52b are aligned with each other. For example, the positioning assembly 7b includes a plurality of limiting sliding rails 71b, a plurality of first positioning portions 72b, and a plurality of second positioning portions 73b. The limiting sliding rails 71b are disposed on the same side of the cassette type electrodialysis units 10A and 10B. The first positioning portions 72b are formed on the outer side of the membrane limiting wall 12 and are combined with the limiting sliding rails 71b, correspondingly. The second positioning portions 73b are formed on the outer sides of the first electrode cassette 51b and the second electrode cassette 52b and are combined with the limiting sliding rail 71b, correspondingly. The first positioning portions 72b and the second positioning portions 73b are, for example, grooves. By combining the limiting sliding rails 71b with the first positioning portions 72b and the second positioning portions 73b corresponding to each other, the cassette type electrodialysis units 10A and 10B, the first electrode cassette 51b and the second electrode cassette 52b can be easily aligned with each other. In other embodiments, the positioning assembly 7b may not be provided on the outer side of the membrane limiting wall 12 of the cassette type electrodialysis units 10A and 10B (details will be described later).

In some embodiments, the clamping assembly 5b includes a plurality of first coupling portions 511b, a plurality of second coupling portions 521b, and a plurality of screw rods 54b. The first coupling portions 511b are formed on the outer side of the first electrode cassette 51b. The second coupling portions 521b are formed on the outer side of the second electrode cassette 52b. The screw rods 54b connects the first coupling portions 511b and the second coupling portions 521b respectively, so that the first electrode cassette 51b, the cassette type electrodialysis units 10A and 10B, and the second electrode cassette 52b are fixed to each other. Since the filter membrane group 2 in each of the cassette type electrodialysis units 10A and 10B in the present disclosure has reached the desired compression ratio, the clamping assembly 5b only needs to apply a lower force to tighten the first electrode cassette 51b, the cassette type electrodialysis units 10A and 10B and the second electrode cassette 52b, and can achieve requirements for the water tightness of the cassette type electrodialysis module 10M.

In some embodiments, the clamping assembly 5b may not include the first coupling portions 511b, the second coupling portions 521b, and the screw rods 54b. On the contrary, the clamping assembly 5b may include fixing members (not shown) disposed on the outer sides of the first electrode cassette 51b, the outer side of the second electrode cassette 52b and the outer side of the cassette type electrodialysis units 10A and 10B. By combining the fixing members on any two adjacent first electrode cassette 51b, the cassette type electrodialysis units 10A and 10B, and the second electrode cassette 52b correspondingly, the tightness and fixation between the first electrode cassette 51b, the second electrode cassette 52b and the cassette type electrodialysis units 10A and 10B can be achieved, which satisfies the requirements for water tightness of the electrodialysis module 10M. The fixing members are, for example, a lock latch, a pin or other suitable fixing member (not shown).

In some embodiments, the first electrode cassette 51b, the second electrode cassette 52b, and the cassette type electrodialysis units 10A and 10B may be respectively provided with rollers (not shown) underneath, so the first electrode cassette 51b, the second electrode cassette 52b, and the cassette type electrodialysis units 10A and 10B can be moved in a more convenient manner.

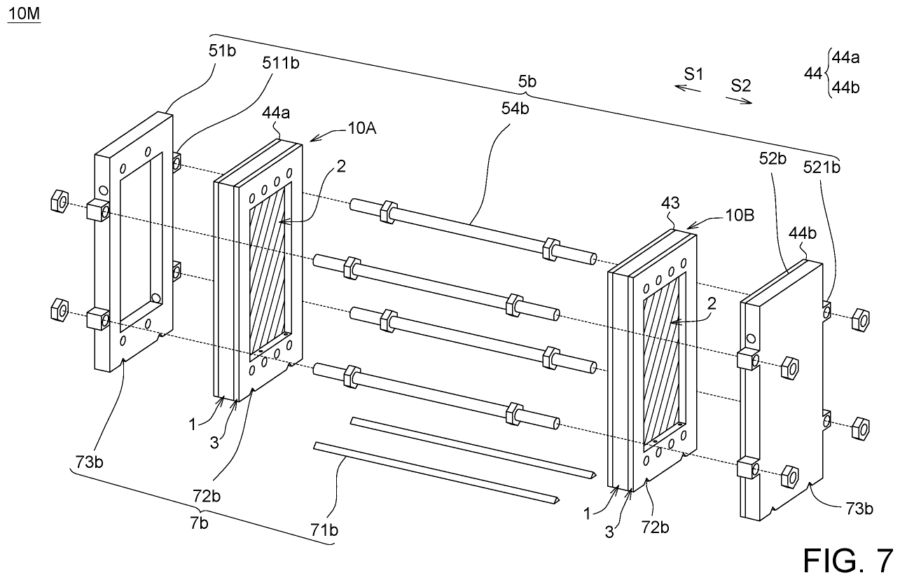

FIG. 9 illustrates a side view of a cassette type electrodialysis module 10N according to a further embodiment of the present disclosure. The difference between the cassette type electrodialysis module 10N and the cassette type electrodialysis module 10M is the number of cassette type electrodialysis units and the number of electrode cassettes, and other identities or similarities will not be repeated.

Referring to FIG. 9, the cassette type electrodialysis module 10N includes a first electrode cassette 51b, a second electrode cassette 52b, a third electrode cassette 53b, a plurality of cassette type electrodialysis units 10A, 10B, 100, 10D . . . , a plurality of third sealing members 43, four fourth sealing members 44a, 44b, 44c, 44d, a clamping assembly 5b (shown in FIG. 8), and a positioning assembly 7b (shown in FIG. 8). However, the present disclosure is not limited thereto. In other embodiments, the cassette type electrodialysis module 10N may not include the clamping assembly 5b. The structure of each of the cassette type electrodialysis unit 10A, 10B, 10C, 10D . . . is the same as that of the cassette type electrodialysis unit 10. The third electrode cassette 53b is disposed between the first electrode cassette 51b and the second electrode cassette 52b, and is inserted into the cassette type electrodialysis units 10A, 10B, 100, 10D . . . . For example, the third electrode cassette 53b is disposed between the cassette type electrodialysis units 100 and 10D. The first electrode cassette 51b, the second electrode cassette 52b, and the third electrode cassette 53b may be used to operate an electric field. When the number of cassette type electrodialysis units 10A, 10B, 100, 10D . . . increases, the distance between the first electrode cassette 51b and the second electrode cassette 52b also increases. If the distance between the first electrode cassette 51b and the second electrode cassette 52b is too far, the current efficiency (equivalent to the desalination efficiency) during the desalination reaction may decrease. Therefore, when the amount of water to be treated increases, which makes the required number of cassette type electrodialysis units 10A, 10B, 100, 10D . . . to be increased, the third electrode cassette 53b may be inserted into the cassette type electrodialysis units 10A, 10B, 100, 10D . . . , so that the distance between the two electrodes is maintained at the best state, and a good current efficiency and desalination efficiency can be maintained, accordingly.

The third sealing members 43 are disposed between each of adjacent two cassette type electrodialysis units 10A, 10B, 10C, 10D . . . . The four fourth sealing members include fourth seals 44a, 44b, 44c, and 44d. The fourth sealing members 44a, 44b, 44c, and 44d are respectively disposed between the first electrode cassette 51b and the cassette type electrodialysis unit 10A, between the second electrode cassette 52b and the cassette type electrodialysis unit 10B, and the third electrode cassette 53b and the cassette type electrodialysis unit 10C and between the third electrode cassette 53b and the cassette type electrodialysis unit 10D.

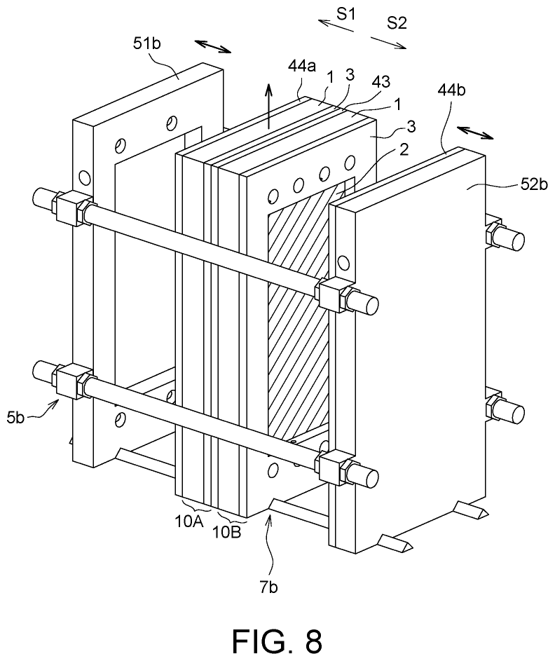

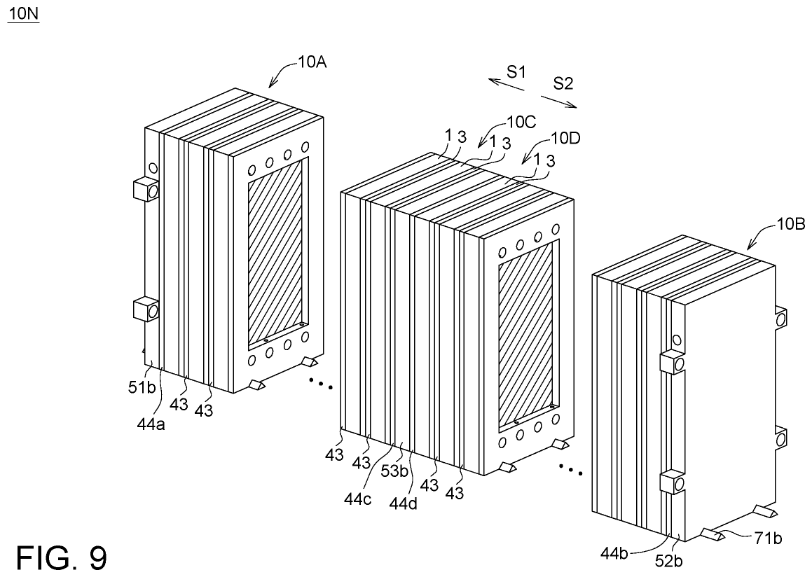

FIG. 10A illustrates a perspective view of the second side of the cassette type electrodialysis unit 20 according to a further embodiment of the present disclosure. FIG. 10B illustrates a perspective view of the first side of the cassette type electrodialysis unit 20 according to a further embodiment of the present disclosure.

The structure of the cassette type electrodialysis unit 20 is similar to that of the cassette type electrodialysis unit 10A, and the cassette type electrodialysis unit 20 is additionally provided with a first positioning portion 17c, and the same and/or similar reference numerals are used for the same and/or similar elements, repetitions will not be described in detail.

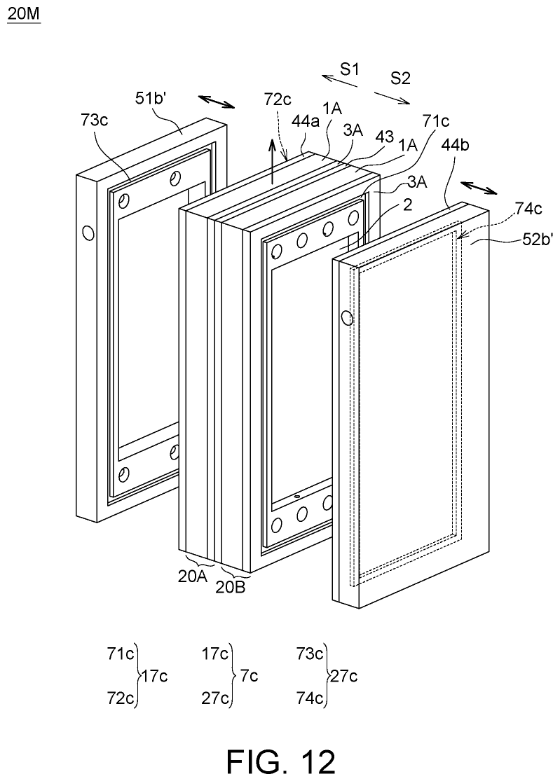

Referring to FIGS. 10A and 10B, the cassette type electrodialysis unit 20 includes an accommodating box 1A, a filter membrane group 2 and a cover member 3A. The first positioning portion 17c is disposed on the first side (corresponding to the first side S1) and the second side (corresponding to the second side S2) of the cassette type electrodialysis unit 20. In the present embodiment, the first positioning portion 17c includes a recessed portion 71c disposed on the second side and a protruding portion 72c disposed on the first side. For example, the recessed portion 71c is disposed on the second side of the cover member 3A, and penetrates a portion of the cover member 3A from the second side of the cover member 3A toward the membrane support 11, and surrounds the opening 33, a first group of holes 3011 and a second group of holes 3012; the protruding portion 72c is disposed on the first side of the accommodating box 1A (that is, the first side of the membrane support 11), and protrudes from a first side of the membrane support 11 to a direction away from the cover member 3A, and surrounds the large holes 1100 and the small holes 1102 (viewed from the first side). The recessed portion 71c and the protruding portion 72c are respectively closed rectangles, but the disclosure is not limited thereto. The recessed portion 71c and the protruding portion 72c disposed on two adjacent cassette type electrodialysis units 20 may be correspondingly engaged with each other (shown in FIG. 12), so a plurality of cassette type electrodialysis units 20 may be positioned to each other through the corresponding first positioning portion 17c (that is, the recessed portion 71c and the protruding portion 72c).

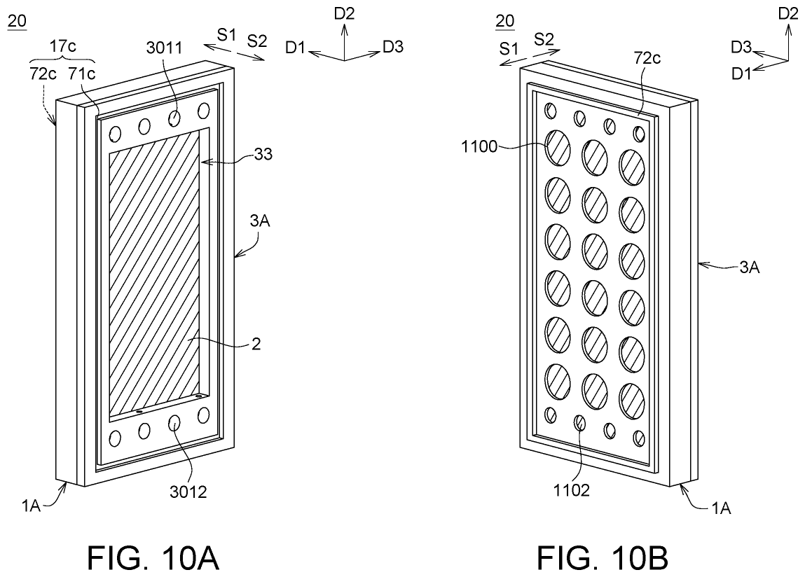

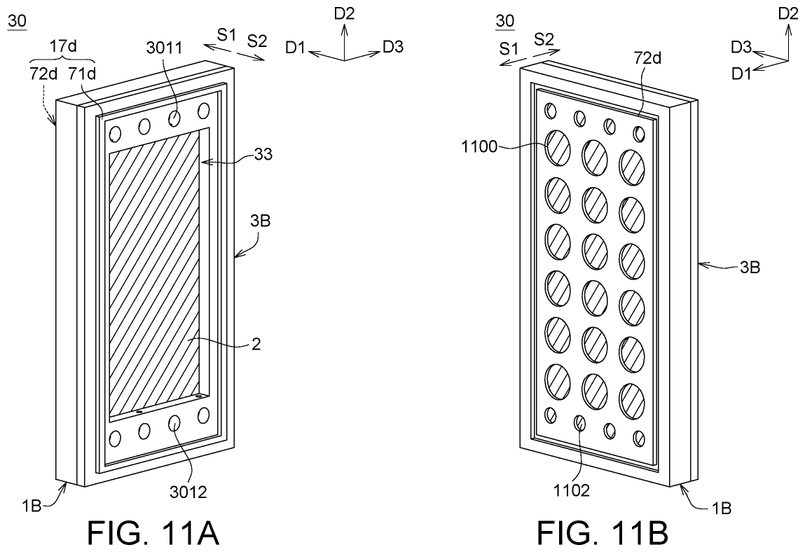

FIG. 11A is a perspective view of the second side of the cassette type electrodialysis unit 30 according to a further embodiment of the present disclosure. FIG. 11B illustrates a perspective view of the first side of the cassette type electrodialysis unit 30 according to a further embodiment of the present disclosure.

The structure of the cassette type electrodialysis unit 30 is similar to that of the cassette type electrodialysis unit 10A, and the cassette type electrodialysis unit 30 is additionally provided with a first positioning portion 17d, and the same and/or similar reference numerals are used for the same and/or similar elements, repetitions will not be described in detail.

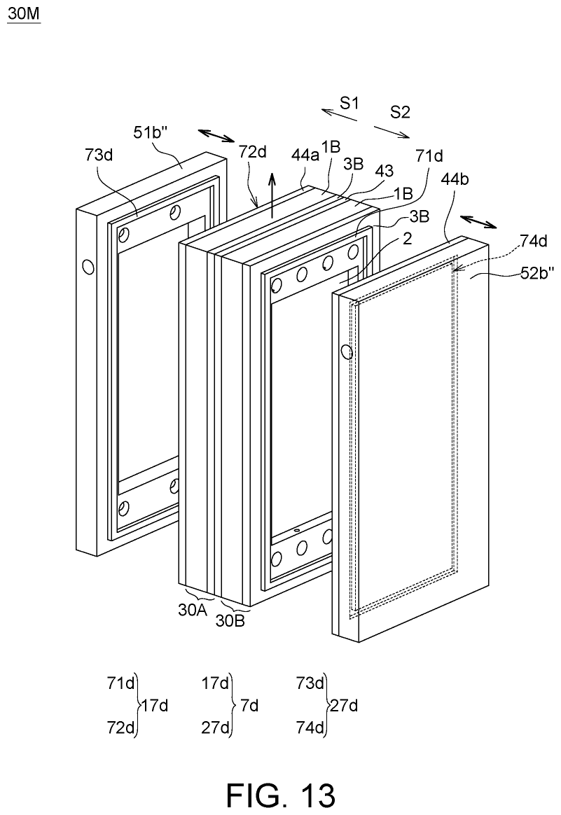

Referring to FIGS. 11A and 11B, the cassette type electrodialysis unit 30 includes an accommodating box 1B, a filter membrane group 2 and a cover member 3B. The first positioning portion 17d is disposed on the first side (corresponding to the first side S1) and the second side (corresponding to the second side S2) of the cassette type electrodialysis unit 30. In the present embodiment, the first positioning portion 17d includes a protruding portion 71d disposed on the second side and a recessed portion 72d disposed on the first side. For example, the protruding portion 71d is disposed on the second side of the cover member 3B, and protrudes from the second side of the cover member 3B toward a direction far away from the membrane support 11, and surrounds the opening 33, the first group of holes 3011, and a second group of holes 3012 (viewed from the second side); the recessed portion 72d is disposed on the first side of the accommodating box 1B (that is, the first side of the membrane support 11), and penetrates a portion of the membrane support 11 from the first side of the membrane support 11 toward the cover member 3B, and surrounds the large holes 1100 and the small holes 1102. The recessed portion 72d and the protruding portion 71d are respectively, for example, closed rectangles, but the disclosure is not limited thereto. The recessed portion 72d and the protruding portion 71d disposed on two adjacent cassette type electrodialysis units 30 may be correspondingly engaged with each other (shown in FIG. 13), so the plurality of cassette type electrodialysis units 30 may be positioned to each other through the corresponding first positioning portion 17d (that is, the protruding portion 71d and the recessed portion 72d).

FIG. 12 is a perspective view of a cassette type electrodialysis module 20M according to a further embodiment of the present disclosure. In the present embodiment, the cassette type electrodialysis module 20M is different from the cassette type electrodialysis module 10M in that the cassette type electrodialysis module 20M may not have a clamping assembly, and the forms of the positioning assemblies are different, other same elements will not be repeated. In other embodiments, the cassette type electrodialysis module 20M may have a clamping assembly.

Referring to FIG. 12, the cassette type electrodialysis module 20M includes a first electrode cassette 51b′, a second electrode cassette 52b′, a plurality of cassette type electrodialysis units 20A and 20B, and a positioning assembly 7c. The cassette type electrodialysis units 20A and 20B are disposed between the first electrode cassette 51b′ and the second electrode cassette 52b′. The cassette type electrodialysis units 20A and 20B are the same as the cassette type electrodialysis unit 20 shown in FIGS. 10A and 10B, respectively. The cassette type electrodialysis module 20M may include any number of cassette type electrodialysis units.

The positioning assembly 7c is disposed on a first side (corresponding to the first side of the first electrode cassette 51b′) and a second side (corresponding to the second side of the second electrode cassette 52b′) of each of the cassette type electrodialysis units 20A and 20B, the first side of each of the cassette type electrodialysis units 20A and 20B is opposite to the second side of each of the cassette type electrodialysis units 20A and 20B, and the second side of the cassette type electrodialysis unit 20A may be adjacent to the first side of the cassette type electrodialysis unit 20B in the two cassette type electrodialysis units 20A and 20B adjacent to each other. Furthermore, the positioning assembly 7c includes a plurality of first positioning portions 17c disposed on the cassette type electrodialysis units 20A and 20B, and a plurality of second positioning portions 27c disposed on the first electrode cassette 51b′ and the second electrode cassette 52b′, such that the cassette type electrodialysis units 20A and 20B, the first electrode cassette 51b′ and the second electrode cassette 52b′ are aligned with each other.

For example, the first positioning portion 17c includes a protruding portion 72c disposed on the first side of each of the cassette type electrodialysis units 20A and 20B, and a recessed portion 71c disposed on a second side of each of the cassette type electrodialysis units 20A and 20B. The protruding portion 72c and the recessed portion 71c of the adjacent cassette type electrodialysis units 20A and 20B are correspondingly combined. The second positioning portion 27c is disposed on one side of the first electrode cassette 51b′ adjacent to the cassette type electrodialysis units 20A and 20B, and on one side of the second electrode cassette 52b′ adjacent to the cassette type electrodialysis units 20A and 20B. The second positioning portion 27c and the corresponding first positioning portion 17c are correspondingly combined with each other. The second positioning portion 27c includes a recessed portion 73c disposed on the first electrode cassette 51b′ and a protruding portion 74c disposed on the second electrode cassette 52b′.

In the present embodiment, the recessed portion 73c of the first electrode cassette 51b′ is engaged with the protruding portion 72c of the cassette type electrodialysis unit 20A, correspondingly; the recessed portion 71c of the cassette type electrodialysis unit 20A is engaged with the protruding portion 72c of the cassette type electrodialysis unit 20B, correspondingly; the recessed portion 71c of the cassette type electrodialysis unit 20B is engaged with the protruding portion 74c of the second electrode cassette 52b′, correspondingly.

FIG. 13 is a perspective view of a cassette type electrodialysis module 30M according to a further embodiment of the present disclosure. In the present embodiment, the cassette type electrodialysis module 30M is different from the cassette type electrodialysis module 10M in that the cassette type electrodialysis module 30M may not have a clamping assembly, but the forms of the positioning assemblies are different, other same elements will not be repeated. In other embodiments, the cassette type electrodialysis module 30M may have a clamping assembly.

Referring to FIG. 13, the cassette type electrodialysis module 30M includes a first electrode cassette 51b″, a second electrode cassette 52b″, a plurality of cassette type electrodialysis units 30A and 30B, and a positioning assembly 7d. The cassette type electrodialysis units 30A and 30B are disposed between the first electrode cassette 51b″ and the second electrode cassette 52b″. The cassette type electrodialysis units 30A and 30B are the same as the cassette type electrodialysis unit 30 shown in FIGS. 11A and 11B, respectively. The cassette type electrodialysis module 30M may include any number of cassette type electrodialysis units.

The positioning assembly 7d is disposed on a first side (corresponding to the first side of the first electrode cassette 51b″) and a second side (corresponding to second side of the second electrode cassette 52b″) of each of the cassette type electrodialysis units 30A and 30B. The first side of each of the cassette type electrodialysis units 30A and 30B is opposite to the second side of each of the cassette type electrodialysis units 30A and 30B, and the second side of the cassette type electrodialysis unit 30A may be adjacent to the first side of the cassette type electrodialysis unit 30B in the two cassette type electrodialysis units 30A and 30B adjacent to each other. Furthermore, the positioning assembly 7d includes a plurality of first positioning portions 17d disposed on the cassette type electrodialysis units 30A and 30B, and a plurality of second positioning portions 27d disposed on the first electrode cassette 51b″ and the second electrode cassette 52b″, such that the cassette type electrodialysis units 30A and 30B, the first electrode cassette 51b″ and the second electrode cassette 52b″ are aligned with each other.

For example, the first positioning portion 17d includes a recessed portion 72d disposed on the first side of each of the cassette type electrodialysis units 30A and 30B, and a protruding portion 71d disposed on the second side of each of the cassette type electrodialysis units 30A and 30B. The protruding portion 71d and the recessed portion 72d of the adjacent cassette type electrodialysis units 30A and 30B is correspondingly combined. The second positioning portion 27d is disposed on one side of the first electrode cassette 51b″ adjacent to the cassette type electrodialysis units 30A and 30B, and on one side of the second electrode cassette 52b″ adjacent to the cassette type electrodialysis units 30A and 30B. The second positioning portion 27d and the corresponding first positioning portion 17d are correspondingly combined with each other. The second positioning portion 27d includes a protruding portion 73d disposed on the first electrode cassette 51b″ and a recessed portion 74d disposed on the second electrode cassette 52b″.

In the present embodiment, the protruding portion 73d of the first electrode cassette 51b″ is engaged with the recessed portion 72d of the cassette type electrodialysis unit 30A; the protruding portion 71d of the cassette type electrodialysis unit 30A is engaged with the recessed portion 72d of the cassette type electrodialysis unit 30B corresponding to each other; the protruding portion 71d of the cassette type electrodialysis unit 30B is engaged with the recessed portion 74d of the second electrode cassette 52b″ corresponding to each other.

In some embodiments, the cassette type electrodialysis modules 20M and 30M may include a third electrode cassette, respectively.

It should be understood that the different features of the above-mentioned embodiments of the present disclosure can be combined with each other.

The present disclosure provides a cassette type electrodialysis unit and a cassette type electrodialysis module. The cassette type electrodialysis unit includes an accommodating box, a filter membrane group and a cover member. The accommodating box includes a membrane support, a membrane limiting wall and an accommodating opening. The membrane limiting wall is disposed on and surrounds the membrane support. The accommodating opening is formed between the membrane support and the membrane limiting wall. The filter membrane group is disposed on the membrane support and abuts the inner side of the membrane limiting wall. The filter membrane group includes a plurality of first ion exchange membranes and a plurality of second ion exchange membranes alternately disposed; and a plurality of spacers. The spacers are disposed between the first ion exchange membranes and the second ion exchange membranes. The cover member is disposed on the accommodating box, and the cover member includes at least one opening, a body portion, and a pressing portion, wherein at least one opening penetrates the body portion, and a first side of the body portion adjacent to the filter membrane group has a peripheral area and an inner area, the inner area is closer to the opening than the peripheral area, and the pressing portion is formed on the inner area.

Compared with the comparative example of the electrodialysis unit without the membrane limiting wall, since the cassette type electrodialysis unit of the present disclosure has the membrane limiting wall, the first ion exchange membranes, the second ion exchange membranes and the spacers may be easily aligned with each other and fixed on the membrane support during stacking the filter membrane group, without the need to spend extra manpower to align the first ion exchange membranes, the second ion exchange membranes and the spacers. Even a large-size filter membrane group may be assembled easily, so it is more time-saving and labor-saving to assemble the cassette type electrodialysis unit, and can more accurately align the first ion exchange membranes and the second ion exchange membranes and the spacers, which can effectively reduce the internal water leakage caused by the deviation of the membrane position, thereby eliminating the risk of mixing of purified water and sewage. In addition, compared with the comparative example without the pressing portion, since the cassette type electrodialysis unit of the present disclosure has the pressing portion disposed on the cover member, a compression stress may be evenly applied to the filter membrane group while the cover member is combined with the accommodating box, and the required compression ratio of the filter membrane group may be achieved in a simple way. In addition to improving the problem of uneven force while compressing the filter membrane group, a better leakage-proof effect can also be provided.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A cassette type electrodialysis unit, comprising an accommodating box, a filter membrane group and a cover member,
wherein the accommodating box comprises:
a membrane support;
a membrane limiting wall disposed on and surrounding the membrane support; and
an accommodating opening formed between the membrane support and the membrane limiting wall;
wherein the filter membrane group is disposed on the membrane support and abuts an inner side of the membrane limiting wall, the filter membrane group comprises:
a plurality of first ion exchange membranes and a plurality of second ion exchange membranes disposed alternately; and
a plurality of spacers disposed between the first ion exchange membranes and the second ion exchange membranes; and
wherein the cover member is disposed on the accommodating box, and the cover member comprises at least one opening, a body portion, and a pressing portion, wherein the at least one opening penetrates the body portion, and a first side of the body portion adjacent to the filter membrane group has a peripheral area and an inner area, the inner area is closer to the opening than the peripheral area, and the pressing portion is formed on the inner area.

2. The cassette type electrodialysis unit according to claim 1, further comprising:
a first sealing member disposed between the membrane support and the filter membrane group; and
a second sealing member disposed between the pressing portion and the filter membrane group, and between the peripheral area and the membrane limiting wall.

3. The cassette type electrodialysis unit according to claim 1, wherein the cover member has an inner surface corresponding to the first side, and a thickness formed by the pressing portion and the body portion disposed in the inner area together is greater than a thickness formed by the body portion disposed in the peripheral area in a normal direction of the inner surface.

4. The cassette type electrodialysis unit according to claim 1, wherein the pressing portion surrounds the opening.

5. The cassette type electrodialysis unit according to claim 1, wherein:
the filter membrane group has a first thickness before the filter membrane group is compressed by the pressing portion; and
the filter membrane group has a second thickness after the filter membrane group is compressed by the pressing portion, wherein the second thickness is smaller than the first thickness.

6. The cassette type electrodialysis unit according to claim 5, wherein the second thickness has a compression percentage to the first thickness, and the compression percentage ranges from 3% to 15%.

7. The cassette type electrodialysis unit according to claim 1, wherein the cover member has an inner surface corresponding to the first side, a plurality of holes extending along a first direction, and a plurality of extending apertures extending along a second direction, respectively, the first direction is parallel to a normal direction of the inner surface, the second direction is perpendicular to the normal direction of the inner surface, and the holes of the cover member penetrate the pressing portion and the body portion, the extending apertures connect corresponding ones of the holes to the opening.

8. The cassette type electrodialysis unit according to claim 7, wherein the holes of the cover member comprise a first group of holes and a second group of holes, the first group of holes and the second group of holes are formed on two opposite sides of the opening, the holes in the first group of holes are separated from each other along a third direction, the holes in the second group of holes are separated from each other along the third direction, the third direction is perpendicular to the first direction and the second direction, wherein
the extending apertures connected to the holes in the first group of holes are separated from the extending apertures connected to the holes in the second group of holes in the second direction.

9. The cassette type electrodialysis unit according to claim 7, wherein the holes of the cover member comprise a first group of holes and a second group of holes, and the first group of holes and the second group of holes of the cover member are formed on two opposite sides of the opening,
wherein each of the first ion exchange membranes comprises a first group of holes and a second group of holes, each of the second ion exchange membranes comprises a first group of holes and a second group of holes, and each of the spacers comprises a first group of holes and a second group of holes, and
wherein the first group of holes of the cover member, the first group of holes of each of the first ion exchange membranes, the first group of holes of each of the second ion exchange membranes, and the first group of holes of each of the spacers correspond to each other; the second group of holes of the cover member, the second group of holes of each of the first ion exchange membranes, the second group of holes of each of the second ion exchange membranes, and the second group of holes of each of the spacers correspond to each other.

10. A cassette type electrodialysis module, comprising:
a plurality of cassette type electrodialysis units and a positioning assembly,
each of the cassette type electrodialysis units comprises an accommodating box, a filter membrane group and a cover member,
wherein the accommodating box comprises:
a membrane support;
a membrane limiting wall disposed on and surrounding the membrane support; and
an accommodating opening formed between the membrane support and the membrane limiting wall;
wherein the filter membrane group is disposed on the membrane support and abuts an inner side of the membrane limiting wall, the filter membrane group comprises:
a plurality of first ion exchange membranes and a plurality of second ion exchange membranes disposed alternately; and
a plurality of spacers disposed between the first ion exchange membranes and the second ion exchange membranes; and
wherein the cover member is disposed on the accommodating box, and the cover member comprises at least one opening, a body portion, and a pressing portion, wherein the at least one opening penetrates the body portion, and a first side of the body portion adjacent to the filter membrane group has a peripheral area and an inner area, the inner area is closer to the opening than the peripheral area, and the pressing portion is formed on the inner area;
wherein the positioning assembly is disposed on an outer side of the membrane limiting wall, so that the cassette type electrodialysis units are aligned with each other.

11. The cassette type electrodialysis module according to claim 10, each of the cassette type electrodialysis units further comprising:
a first sealing member disposed between the membrane support and the filter membrane group; and
a second sealing member disposed between the pressing portion and the filter membrane group, and between the peripheral area and the membrane limiting wall.

12. The cassette type electrodialysis module according to claim 11, further comprising a third sealing member disposed between the cassette type electrodialysis units.

13. The cassette type electrodialysis module according to claim 10, wherein the positioning assembly further comprising:
a plurality of limiting sliding rails disposed on a same side of the cassette type electrodialysis units; and
a plurality of first positioning portions formed on the outer side of the membrane limiting wall and correspondingly combined with the limiting sliding rails.

14. The cassette type electrodialysis module according to claim 12, further comprising:
a first electrode cassette and a second electrode cassette, wherein the cassette type electrodialysis units are disposed between the first electrode cassette and the second electrode cassette; and
two fourth sealing members disposed between the first electrode cassette and the cassette type electrodialysis unit closest to the first electrode cassette in the cassette type electrodialysis units, and disposed between the second electrode cassette and the cassette type electrodialysis unit closest to the second electrode cassette in the cassette type electrodialysis units, respectively.

15. The cassette type electrodialysis module according to claim 14, further comprising a third electrode cassette, the third electrode cassette is disposed between the first electrode cassette and the second electrode cassette, and inserted into the cassette type electrodialysis units.

16. The cassette type electrodialysis module according to claim 14, wherein the positioning assembly further comprising:
a plurality of limiting sliding rails disposed on a same side of the cassette type electrodialysis units;
a plurality of first positioning portions formed on the outer side of the membrane limiting wall and correspondingly combined with the limiting sliding rails; and
a plurality of second positioning portions formed on an outer side of the first electrode cassette and the second electrode cassette and are correspondingly combined with the limiting sliding rails.

17. The cassette type electrodialysis module according to claim 14, further comprising a clamping assembly, the clamping assembly comprising:
a plurality of first coupling portions formed on an outer side of the first electrode cassette;
a plurality of second coupling portions formed on an outer side of the second electrode cassette; and
a plurality of screw rods connected with the first coupling portions and the second coupling portions, respectively, so that the first electrode cassette, the cassette type electrodialysis units and the second electrode cassette are fixed to each other.

18. A cassette type electrodialysis module, comprising:
a plurality of cassette type electrodialysis units and a positioning assembly,
each of the cassette type electrodialysis units comprises an accommodating box, a filter membrane group and a cover member,
wherein the accommodating box comprises:
a membrane support;
a membrane limiting wall disposed on and surrounding the membrane support; and
an accommodating opening formed between the membrane support and the membrane limiting wall;
wherein the filter membrane group is disposed on the membrane support and abuts an inner side of the membrane limiting wall, the filter membrane group comprises:
a plurality of first ion exchange membranes and a plurality of second ion exchange membranes disposed alternately; and
a plurality of spacers disposed between the first ion exchange membranes and the second ion exchange membranes; and
wherein the cover member is disposed on the accommodating box, and the cover member comprises at least one opening, a body portion, and a pressing portion, wherein the at least one opening penetrates the body portion, and a first side of the body portion adjacent to the filter membrane group has a peripheral area and an inner area, the inner area is closer to the opening than the peripheral area, and the pressing portion is formed on the inner area;
wherein the positioning assembly is disposed on a first side and a second side of each of the cassette type electrodialysis units, and the first side of each of the cassette type electrodialysis units is opposite to the second side of each of the cassette type electrodialysis units.

19. The cassette type electrodialysis module according to claim 18, wherein the positioning assembly further comprises a plurality of first positioning portions, and the first positioning portions comprises a recessed portion disposed on the first side of each of the cassette type electrodialysis units, and a protruding portion disposed on a second side of each of the cassette type electrodialysis units, the recessed portion and the protruding portion of adjacent ones of the cassette type electrodialysis units are correspondingly combined.

20. The cassette type electrodialysis module according to claim 19, further comprising a first electrode cassette and a second electrode cassette, wherein the cassette type electrodialysis units are disposed between the first electrode cassette and the second electrode cassette;
wherein the positioning assembly further comprises a plurality of second positioning portions, and the second positioning portions are disposed on one side of the first electrode cassette adjacent to the cassette type electrodialysis units and one side of the second electrode cassette adjacent to the cassette type electrodialysis units, the second positioning portions and corresponding ones of the first positioning portions are combined with each other, correspondingly.
